(19) United States
(12) Patent Application Publication
(10) Pub. No.: US 2004/0109494 A1
(43) Pub. Date: Jun. 10, 2004

(54) Finger merge protection for rake receivers using polling

(76) Inventors: Daniel R. Kindred, La Jolla, CA (US); Jeffrey A. Levin, San Diego, CA (US); Rajesh Sundaresan, Santa Clara, CA (US)

Correspondence Address: Qualcomm Incorporated, Patents Department, 5775 Morehouse Drive, San Diego, CA, 92121-1714, US

(21) Appl. No.: 10/316,758

(22) Filed: Dec. 10, 2002

(51) Int. Cl. H04B 1/707

(52) U.S. Cl. 375/148

(57) ABSTRACT

Techniques for performing finger merge protection (FMP) using polling. Whenever a command to adjust the timing of a designated finger is received, other fingers “on the same channel” (i.e., those for which merge protection is sought) are polled for permission to apply the command. The designated finger sets a poll request and provides other pertinent information to an FMP storage unit. Thereafter, each of the other fingers on the same channel determines whether or not applying the command would result in that finger merging with the designated finger. Merging may be detected if the difference between the timing (or offsets) of the two fingers is less than a specified offset spacing. Any finger on the same channel may disallow the command if merging is detected. The designated finger would then adjust its timing if the command is not disallowed by any of the fingers on the same channel.

### BACKGROUND

1. Field

The present invention relates generally to data communication, and more specifically to techniques for protecting against merging of demodulation elements (or fingers) assigned to process multipath components of a transmitted signal in a wireless communication system.

2. Background

In a wireless communication system, a modulated signal transmitted from a transmitter (e.g., a terminal) may reach a receiver (e.g., a base station) via a number of signal paths due to artifacts in the propagation environment (e.g., building, natural structures, and so on). The received signal at the receiver may thus include a number of multipath components, each of which corresponds to a signal instance received via a particular signal path. Since the receiver may also receive signals from multiple transmitters, the received signal may include a number of multipath components for a number of transmitters.

For a digital system, a rake receiver is often used to process a number of multipath components in the received signal for a given transmitter (e.g., a given terminal). The rake receiver normally includes one or more searcher elements (or simply “searchers”) and a number of demodulation elements (often referred to as “fingers”). Each searcher may be operated to process the received signal to search for strong multipath components. Each finger may then be assigned to process a particular multipath component of sufficient strength. By assigning a number of fingers to process a number of multipath components for a given transmitter and combining symbol estimates from all assigned fingers, more of the energy in the received signal may be collected and improved performance may be achieved.

Each multipath component is associated with a particular propagation delay and a particular time of arrival at the receiver, both of which are determined by the signal path. For a wireless communication channel, and especially for a mobile environment, the signal paths may continually change over time. Thus, as part of the signal processing, a time tracking loop is normally maintained for each active finger and used to track the timing of the multipath component assigned to the finger. Each time tracking loop would advance or retard its timing, as necessary, so that it remains locked to the changing arrival time of the assigned multipath component.

As the signal paths change, the arrival times of two or more multipath components for a given transmitter may approach close to each other. When the difference between the arrival times of the multipath components is equal to or less than a particular value, the multipath components appear as an energy “blob” and the assigned fingers are not able to resolve them. Consequently, these fingers would end up tracking the same multipath component, a phenomenon often referred to as “finger merging”. This merging effect is undesirable because the fingers would not be able to track the individual multipath components when the signal paths subsequently change and the multipath components move away from each other. Once merged, the fingers cannot be easily separated, and the benefits obtained by assigning multiple fingers to process the received signal are lost.

There is therefore a need in the art for techniques to prevent the fingers of a rake receiver from merging together.

### SUMMARY

Techniques are provided herein for performing finger merge protection (FMP) using polling. These techniques allow the fingers to be operated independently and can provide other advantages such as simplified processing for finger merge protection.

For finger merge protection with polling, whenever a command to adjust the timing of a designated finger is received, other fingers “on the same channel” (i.e., those for which merge protection is sought) are polled for permission to apply the command. The designated finger sets a poll request and provides other pertinent information to an FMP storage unit. Thereafter, each of the other fingers on the same channel determines whether or not applying the command would result in that finger merging with the designated finger. Merging may be detected if the difference between the timing (or offsets) of the two fingers is less than or equal to a specified spacing (e.g., ⅞ PN chip). Any finger on the same channel may disallow the command if merging is detected. The designated finger would then adjust its timing if the command is not disallowed by any of the fingers on the same channel.

Various aspects and embodiments of the invention are described in further detail below.

### BRIEF DESCRIPTION OF THE DRAWINGS

The features, nature, and advantages of the present invention will become more apparent from the detailed description set forth below when taken in conjunction with the drawings in which like reference characters identify correspondingly throughout and wherein:

FIG. 1 is a simplified block diagram of a base station and a terminal in a wireless communication system;

FIG. 2 is a block diagram of a demodulator that implements a rake receiver;

FIG. 3 shows an example received signal from one antenna;

FIG. 4 shows an implementation of the rake receiver in FIG. 2;

FIG. 5 shows a timeline for finger offset adjustment with finger merge protection using polling;

FIG. 6 illustrates the polling of fingers in sequential order for a poll request;

FIG. 7 shows a process for performing finger merge protection with polling;

FIG. 8 shows a process for polling other fingers for possible merging with a requesting finger; and

FIG. 9 shows a process that may be performed by each finger for merge protection.

### DETAILED DESCRIPTION

The finger merge protection techniques described herein may be used for both uplink (reverse link) transmissions from the terminals to the base stations and downlink (forward link) transmissions from the base stations to the terminals. For clarity, these techniques are specifically described for uplink transmissions.

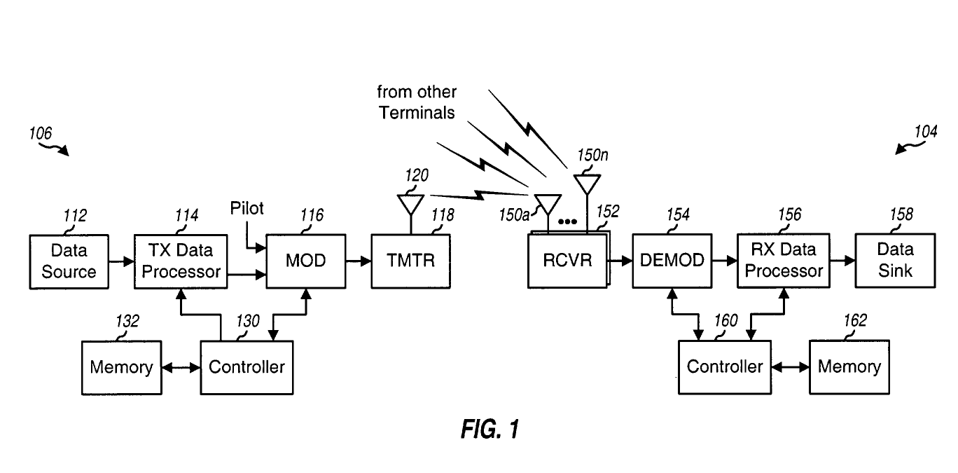

FIG. 1 is a simplified block diagram of a base station 104 and a terminal 106 in a wireless communication system (e.g., a CDMA system). On the uplink, at terminal 106, a transmit (TX) data processor 114 receives different types of traffic such as user-specific data from a data source 112 and signaling from a controller 130. TX data processor 114 then formats and codes the data based on one or more coding schemes to provide coded data.

A modulator (MOD) 116 further processes the coded data from TX data processor 114 and pilot data to provide modulated data. For a CDMA system, modulator 116 “spreads” or “covers” the coded and pilot data with different channelization codes to channelize the user-specific data, signaling data, and pilot data onto their respective code channels. For a CDMA system, modulator 116 further spectrally spreads the channelized data with a spreading sequence. On the uplink in a cdma2000 system, the spreading sequence for each terminal is generated based on (1) a complex pseudo-random number (PN) sequence that is common to all terminals and (2) a scrambling sequence that is specific to the terminal. Thus, the pilots from different terminals may be identified by their different spreading sequences.

The modulated data is then provided to a transmitter (TMTR) 118 and conditioned to generate an uplink modulated signal. The conditioning may include conversion to one or more analog signals, amplification, filtering, and frequency upconversion. The uplink modulated signal is then transmitted via an antenna 120 and over a wireless link to one or more base stations.

At base station 104, the uplink modulated signals transmitted from a number of terminals are received by each of one or more antennas 150. Multiple antennas may be used at the base station to provide spatial diversity against deleterious path effects such as fading. As an example, for a base station that supports three sectors, two antennas may be used for each sector and the base station may then include six antennas. Any number of antennas may be employed at the base station.

Each received signal is provided to a respective receiver unit (RCVR) 152, which may also be referred to as a “front-end” unit. Each receiver unit 152 conditions (e.g., filters, amplifies, and frequency downconverts) its received signal and further digitizes the conditioned signal to provide a stream of data samples for that received signal. Each receive signal may include one or more signal instances (i.e., multipath components) for each of a number of terminals.

A demodulator (DEMOD) 154 then processes the data samples for all received signals to provide demodulated data. Demodulator 154 may implement a rake receiver that can process a number of multipath components in each received signal, as described below. A receive (RX) data processor 156 then decodes the demodulated data to recover the user-specific data and signaling data transmitted on the uplink by each active terminal. The processing by demodulator 154 and RX data processor 156 is complementary to that performed by modulator 116 and TX data processor 114, respectively, at the terminals.

Controllers 130 and 160 direct the operation at the terminal and base station, respectively. Memories 132 and 162 provide storage for program codes and data used by controllers 130 and 160, respectively.

The terminology used to describe the processing by modulator 116 at the terminal and demodulator 154 at the base station is typically different for different CDMA standards. For W-CDMA, the channelization is referred to as “spreading” and the spectral spreading is referred to as “scrambling”. The channelization codes for the “spreading” are orthogonal variable spreading factor (OVSF) codes, and the spreading sequences for the “scrambling” are referred to as scrambling codes. For IS-95 and IS-2000, the channelization is referred to as “covering” and the spectral spreading is referred to as “spreading”. The channelization codes for the “covering” are Walsh codes or quasi-orthogonal codes, and the spreading sequences are referred to as pseudo-random number (PN) sequences. The base station and terminal are referred to as node B and user equipment (UE), respectively, in W-CDMA. A terminal may also be referred to as a mobile station, a remote station, an access terminal, or some other terminology.

The finger merge protection techniques described herein may be used for various digital standards and designs. For clarity, these techniques are specifically described for W-CDMA.

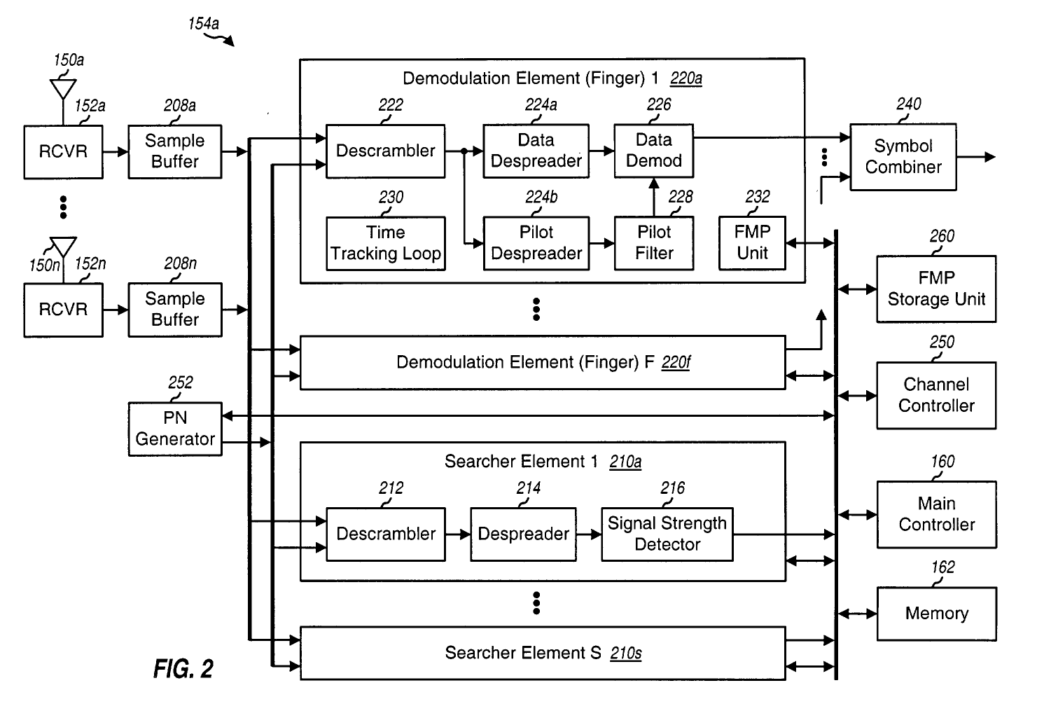

FIG. 2 is a block diagram of a demodulator 154a, which is one embodiment of demodulator 154 in FIG. 1. Demodulator 154a implements a rake receiver that includes S searcher elements 210 (or simply “searchers”) and F demodulation elements 220 (or simply “fingers”), where S and F can each be any integer one or greater. Each searcher 210 may be used to search for strong multipath components in a given received signal and to provide an indication of the strength and timing of each found multipath component that meets one or more criteria. Typically, each active searcher 210 searches for the pilots transmitted from the terminals to find these multipath components.

One finger 220 may then be assigned to process each multipath component of interest (e.g., as determined by controller 160 based on the signal strength and timing information provided by searchers 210). As used herein, an “active” finger is one that is assigned to process a particular multipath component. Each active finger processes its assigned multipath component to provide demodulated symbols for that multipath component. The demodulated symbols from all active fingers assigned to a particular data transmission (e.g., from a particular terminal) may be combined to provide recovered symbols for that data transmission.

As shown in FIG. 2, the data sample stream for each received signal is provided to a respective sample buffer 208, which stores the data samples for subsequent processing by searchers 210 and fingers 220. Buffers 208 provide the stored data samples to the searchers and fingers as they are needed. A PN generator 252 provides “PN segments” (described below) used by the searchers and fingers.

Each searcher 210 operates in conjunction with controller 160 and PN generator 252. For each active searcher 210, data samples are retrieved from the proper sample buffer 208 and provided to a descrambler 212. Descrambler 212 typically receives one data segment at a time along with a corresponding PN segment, where each segment spans a particular time duration (e.g., a specific number of PN chips, where one PN chip is the time period for one chip or bit in the scrambling sequence). The PN segment is a portion of the (complex conjugated) scrambling code sequence used by the terminal whose signal is being searched. The PN segment also has a specific phase corresponding to the hypothesis being evaluated. Descrambler 212 multiplies the data samples with the PN segment and provides descrambled samples. A despreader 214 then despreads the descrambled samples with a channelization code for the pilot (which is OVSF code of zero in W-CDMA) to provide pilot samples. A signal strength detector 216 estimates the signal strength of the pilot for the hypothesis being evaluated and provides the estimated signal strength to controller 160.

A number of hypotheses are typically evaluated to search for multipath components, with each hypothesis corresponding to a particular arrival time and a corresponding scrambling code phase. Due to the pseudo-random nature of the scrambling code, the correlation of the data samples with the scrambling sequence should result in a low value, except when the phase of the locally-generated scrambling sequence is time-aligned with that of a multipath component in the received signal, in which case the correlation results in a high value.

Within each active finger 220, the data samples are provided (typically one segment at a time from the proper sample buffer) to a descrambler 222, which also receives a corresponding PN segment from PN generator 252 for each data segment. Each PN segment is associated with a specific phase that is dependent on (1) the arrival time of the multipath component being processed by the finger and (2) the specific data segment being processed. This arrival time is initially determined by the searcher and is thereafter tracked by a time tracking loop 230 maintained for the finger. Descrambler 222 multiplies the data samples in each segment with the corresponding PN segment and provides descrambled samples.

Data and pilot despreaders 224a and 224b then despread the descrambled samples with the OVSF codes for the traffic data and the pilot, respectively. The despreading is achieved by multiplying the descrambled samples with an OVSF code and accumulating over the length of the OVSF code, as is known in the art. The pilot samples from despreader 224b are further filtered and interpolated by a pilot filter 228 to provide pilot estimate. A data demodulator 226 then demodulates the despread samples from despreader 224a with the pilot estimate to provide demodulated symbols for the assigned multipath component.

A symbol combiner 240 combines the demodulated symbols from all fingers that have been assigned to process a given data transmission. Symbol combiner 240 provides recovered symbols, which may further be decoded to recover the transmitted data. The design and operation of a rake receiver such as that shown in FIG. 2 is described in further detail in the U.S Pat. Nos. 5,764,687 and 5,490,165, which are incorporated herein by reference.

Demodulator 154a may be implemented in various manners. In a “parallel” demodulator design, each finger is implemented as a separate hardware unit, and multiple fingers may be operated simultaneously. In a “TDM” demodulator design, a single processing unit performs all of the required finger processing (e.g., descrambling, despreading, data demodulation, finger merge protection, and so on), and the active fingers are implemented in a time division multiplexed (TDM) manner by the processing unit. For example, the processing unit can perform the required processing for finger 1 in a first set of clock cycles, then perform the required processing for finger 2 in a second set of clock cycles, and so on. For the TDM demodulator design, one hardware unit can implement all active fingers with different “finger slots”, where each finger slot includes a set of clock cycles designated for a particular finger. All active fingers may be cycled through in each “finger cycle” (e.g., N_{F} active fingers may be cycled through by the processing unit in one finger cycle comprised of N_{F} finger slots). Each finger's turn would come up once in each finger cycle, and the finger that is currently being processed/implemented by the processing unit is referred to as the “activated” finger.

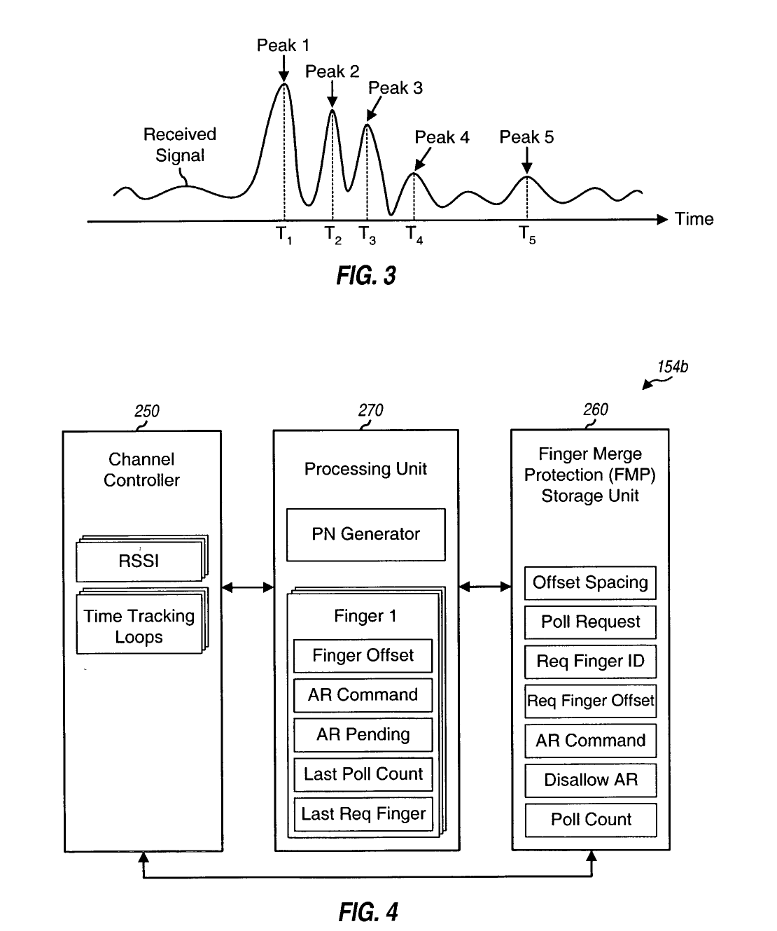

FIG. 3 shows an example of a received signal for one base station antenna. The modulated signal transmitted by each terminal may be received by the base station via a number of signal paths. The received signal for each base station antenna may thus include a number of multipath components for one or more terminals. Each multipath component is associated with a particular amplitude and time of arrival at the base station. In the example shown in FIG. 3, multipath components (or peaks) 1 through 5 are associated with arrival times T₁ through T₅, respectively. The profile of the multipath components in the received signal is determined by the wireless channel and typically varies over time. At any given moment, there may be multipath components clustered close to one another. A “fat path” condition would arise if there are two multipath components separated by less than one PN chip.

Fingers are assigned to process multipath components of sufficient strength found by the searcher. Each finger would track the timing (or arrival time) of its assigned multipath component as it moves about due to changes in the signal path. As each multipath component drifts in time, it may come close to or may even cross over one or more other multipath components in the same received signal. When the difference in arrival times (i.e., the distance) between two multipath components in the same received signal is less than a particular value (which may be ⅞ PN chip for some rake receiver designs), the fingers are not able to resolve these individual multipath components. Consequently, the fingers would “merge” and end up tracking the same multipath component, which is typically the stronger of the two. When these multipath components drift apart again, the merged fingers would continue to track the stronger multipath component. Performance would then be degraded because the energy from the other multipath component is not collected.

A finger merge protection mechanism is used to detect when the multipath components drift too close to each other and to prevent their assigned fingers from merging. This mechanism ensures that a certain minimum distance or spacing is maintained between the timing of any two assigned fingers. If the difference between the timing of any two fingers is equal to or less than the minimum spacing, then the finger merge protection mechanism would not allow these fingers to move towards each other but would allow them to move apart.

In an aspect, techniques are provided to perform finger merge protection using polling. Whenever a particular finger wants to adjust its timing as directed by its time tracking loop, the other fingers on the same channel are polled for permission to adjust the timing. As used herein, fingers on the same channel refer to fingers for which merge protection is sought, which are typically fingers assigned to process multipath components in the same received signal (or same base station antenna) for a given terminal. For simplicity, a finger's timing is normally expressed relative to a reference time, i.e., as an offset from the reference time. The finger offset or timing offset would then indicate the finger's timing.

For each new command to adjust the offset of a particular finger, a poll request and other pertinent information are written to an FMP storage unit. Thereafter, each of the other fingers on the same channel checks the poll request and determines whether or not command if applied would result in that finger merging with the requesting finger that sets the poll request. Any finger on the same channel may disallow the command if merging is detected. The requesting finger would then adjust its offset if the command is not disallowed by any of the fingers on the same channel, and would discard the command otherwise.

For clarity, the finger merge protection with polling is described below for the TDM demodulator design (which is described above).

FIG. 4 is a block diagram of a demodulator 154b, which is one implementation of the rake receiver shown in FIG. 2. In this embodiment, a channel controller 250 implements the time tracking loops for all of the active fingers, and a processing unit 270 implements the active fingers in a TDM manner.

For each active finger that is assigned to process a particular multipath component, the commands to adjust the finger's timing offset are provided by that finger's time tracking loop. The adjustment may be in the form of an advance of the finger offset by a particular amount or a retard of the finger offset by another particular amount. The advance and retard amounts may be −⅛ PN chip and +⅛ PN chip, respectively. The adjustment commands may then be referred to as advance/retard (AR) commands. The time tracking loops within channel controller 250 provide the AR commands for the associated fingers.

Each finger is associated with a set of registers that stores various parameter values for the finger. These parameter values may include:

Finger Offset—the current offset of the finger.

AR Command—the AR command provided by the associated time tracking loop.

AR Pending—indicates whether or not there is a pending AR command for the finger (i.e., one that has been received but not yet applied).

Last Poll Count—the last poll count from the FMP storage unit when merge protection processing was last performed for the finger.

Last Req Finger—the identifier of the finger with the last pool request.

An FMP storage unit 260 includes a set of registers that stores various parameter values used for finger merge protection. These parameter values may include:

Offset Spacing—the minimum difference allowed between the offsets of any two fingers on the same channel. The same offset spacing may apply to all fingers on a given channel, or each finger may be associated with its own offset spacing.

Poll Request—indicates whether or not a poll request is currently pending.

Req Finger ID—the identifier of the finger requesting the poll.

Req Finger Offset—the current offset of the requesting finger (with the pending AR command for that finger not applied).

AR Command—the AR command that is pending for the requesting finger.

Disallow AR—indicates whether or not the pending AR command for the requesting finger is disallowed because merging is detected by at least one finger on the same channel.

Poll Count—indicates the current poll count. Incremented by one whenever a new poll request is written to the FMP storage unit.

The parameter values for the fingers and the FMP storage unit may also be stored in a memory (e.g., a RAM, Flash, and so on) instead of registers.

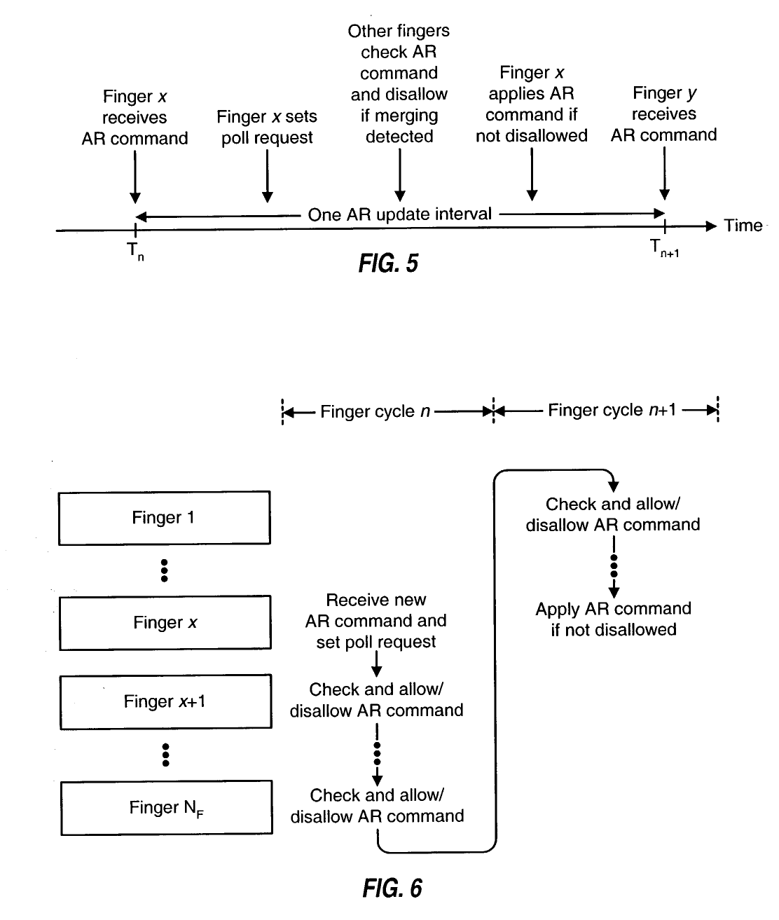

FIG. 5 shows a timeline for finger offset adjustment with finger merge protection using polling. Finger x initially receives an AR command from its time tracking loop. Finger x then sets a poll request for the AR command. Thereafter, each finger on the same channel checks the AR command and disallows it if merging is detected. Finger x would then apply the AR command only if it was not disallowed. The AR command is received, checked, and applied within one AR update interval.

For simplicity, the following description assumes that the finger offset adjustment is performed in a sequential manner (i.e., one AR command for one finger is issued, polled, and applied before another AR command for the same or another finger is issued). However, the finger offset adjustment may also be performed in a pipeline or parallel manner, where multiple AR commands may be pending at any given time, and this is within the scope of the invention.

FIG. 6 illustrates the polling of the fingers in sequential order for a poll request. In this implementation, the active fingers are cycled through in sequential order, and the merge protection processing for each finger is performed when its turn comes up. Finger x receives a new AR command and sets a poll request. Each subsequent finger that is cycled through then checks the AR command for the pending poll request, detects for merging, and either allows or disallows the AR command. When the requesting finger's turn comes up again, it applies the AR command if not disallowed. The sequential polling of the fingers may be used in conjunction with the TDM demodulator design. In this case, the merge protection processing for each finger may be performed whenever the finger's turn comes up and it is implemented by the processing unit. The sequential polling may simplify the merge protection processing and hardware requirement.

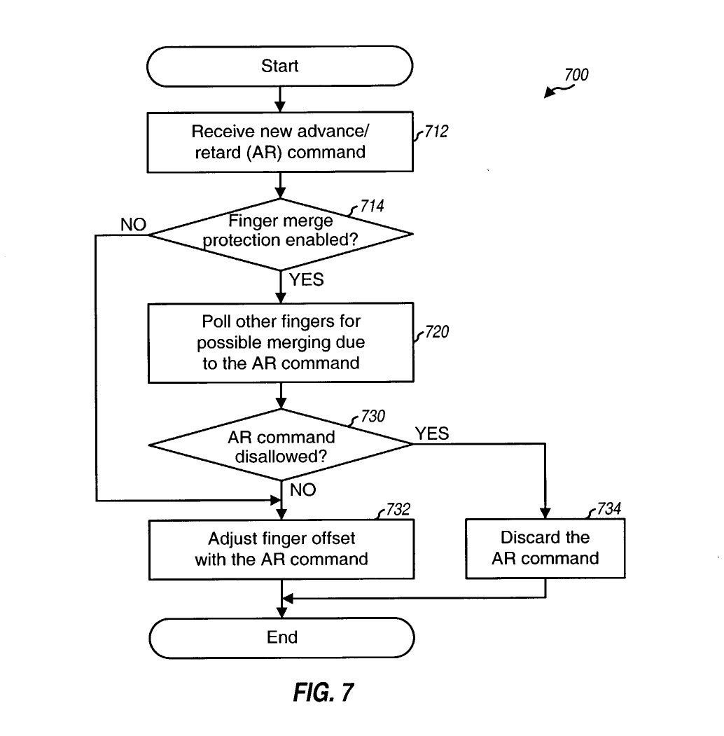

FIG. 7 is a flow diagram of an embodiment of a process 700 for performing finger merge protection with polling. Process 700 is performed by a particular finger to update its timing for each new AR command.

Initially, the finger receives a new AR command from the associated time tracking loop (step 712). A determination is then made whether or not finger merge protection is enabled (step 714). The demodulator may be designed such that finger merge protection may be selectively enabled/disabled for the entire demodulator; enabled for some fingers and disabled for some other fingers, and so on. If finger merge protection is not enabled for this finger, then the process proceeds to step 732.

Otherwise, if finger merge protection is enabled, then other fingers are polled for possible merging with this finger (step 720). The polling may be applied to only fingers on the same channel as this finger. The polling may be performed as described in further detail below.

After all fingers on the same channel have checked the AR command for possible merging, a determination is made whether or not the command is disallowed by any one of these fingers (step 730). If the answer is no, then the offset of this finger is adjusted in accordance with the AR command (step 732). Otherwise, the AR command is discarded if it is disallowed (step 734). The process then terminates.

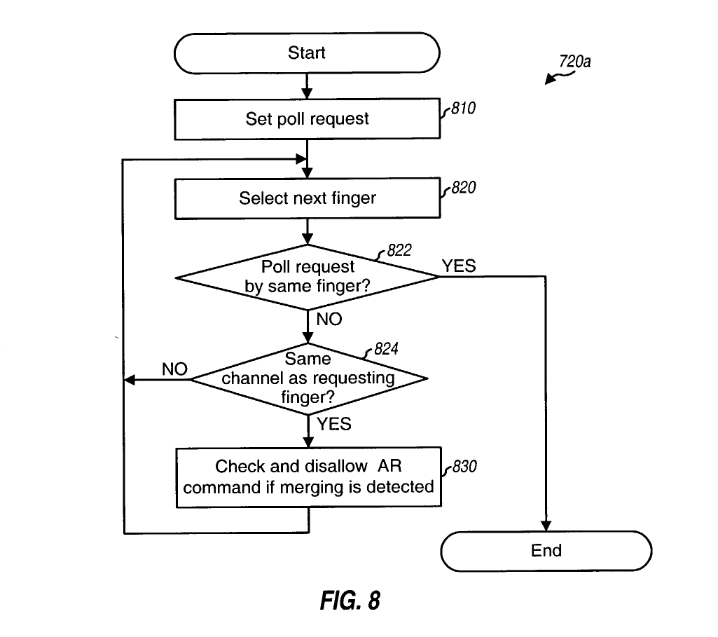

FIG. 8 is a flow diagram of an embodiment of a process 720a for polling other fingers for possible merging with a requesting finger. Process 720a, which may be used for step 720 in FIG. 7, polls the fingers in sequential order, as shown in FIG. 6.

Initially, the finger with the new AR command sets a poll request (step 810). This finger is then referred to as the requesting finger. The poll request may be set by initializing a set of registers with a set of parameter values, as described below.

The fingers are then cycled through for the processing of the poll request. The active fingers may be assigned sequentially numbered identifiers (e.g., from 1 to N_{F} for N_{F} active fingers). These fingers may be processed in sequential order based on their identifiers. The next active finger is selected for evaluation (step 820). For the first iteration through the loop, the selected finger is the one right after the requesting finger.

A determination is then made whether or not the selected finger is the same as the requesting finger (step 822). If the answer is yes, then this indicates that all fingers have been polled and the process terminates. Otherwise, a determination is next made whether or not the selected and requesting fingers are on the same channel (i.e., whether merge protection is needed between these fingers) (step 824). If the answer is no, then the process returns to step 820 to select the next active finger for evaluation. Otherwise, the AR command for the requesting finger is checked for possible merging between the selected and requesting fingers (step 830). The AR command is disallowed if it would result in the requesting finger merging with the selected finger. The process then returns to step 820.

After all fingers have been cycled through, as determined in step 822, the AR command is disallowed if merging is detected by any finger on the same channel, and not disallowed otherwise.

For some demodulator designs, it may be advantageous to operate the fingers independently (i.e., without or with minimal interaction between the fingers). However, the merge protection processing requires some amount of interaction between the fingers. Independent operation of the fingers may be achieved by implementing the merge protection processing within each finger and using a polling scheme. For the embodiment shown in FIG. 2, the merge protection processing for each finger may be performed by FMP unit 232 within the finger.

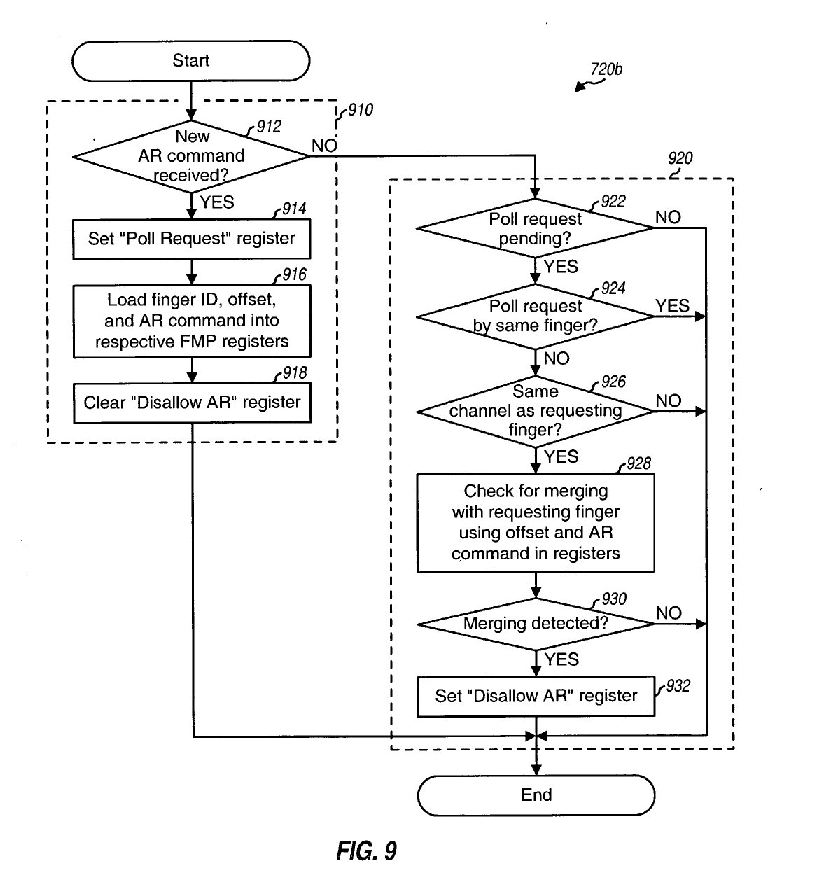

FIG. 9 is a flow diagram of an embodiment of a process 720b that may be performed by each finger for merge protection. Process 720b may be performed by the FMP unit of each finger whenever the finger's turn comes up in the finger cycle.

Process 720b includes two sets of steps. The steps in block 910 are performed to set a poll request if a new AR command is received. The steps in block 920 are performed to detect for merging if a poll request is pending. Process 720b assumes that one AR command is issued, polled, and applied before the next AR command is issued, as illustrated in FIG. 5. Thus, only the steps in block 910 need to be performed if a new AR command is received, and the steps in block 920 are performed otherwise.

Initially, a determination is made whether or not a new AR command is received by the current finger, i.e., the finger for which process 720b is performed (step 912). If the answer is no, then the process skips the rest of the steps in block 910 and proceeds to step 922 in block 920. Otherwise, a poll request is set for the new AR command by initializing a set of registers in the FMP storage unit with a set of parameter values. The current finger is then deemed as the requesting finger. The initializing may include:

Setting the Poll Request register (e.g., to “1”) (step 914);

Loading the Req Finger ID register with the requesting finger ID (step 916);

Loading the Req Finger Offset register with the current offset of the requesting finger (step 916);

Loading the AR Command register with the pending AR command for the requesting finger (step 916);

Clearing the Disallow AR register (e.g., to “0”) (step 918); and

Incrementing the value in the Poll Count register (not shown in FIG. 9).

After setting the poll request, the process terminates to allow the poll request to take effect and for the other fingers to check the AR command. The steps in block 910 may be performed for step 810 in FIG. 8.

Within block 920 (for the processing to detect merging), a determination is first made whether or not there is a pending poll request (step 922). This may be determined by checking the Poll Request register in the FMP storage unit to see if it has been set. If the answer is no, then the process terminates. Otherwise, a determination is next made whether or not the finger that requested the pending poll is the same as the current finger (step 924). This determination may be made by comparing the requesting finger ID (which is stored in the Req Finger ID) against the current finger ID. If the current finger is the one that requested the poll, then this would indicate that all fingers have been polled for the pending AR command and the merge protection processing has cycled back to the requesting finger, as illustrated in FIG. 6. The process would then terminate and the pending AR command would be applied if it is not disallowed, as shown in FIG. 7. Although not shown in FIG. 7, the current finger would also clear the Poll Request register in the FMP storage unit to indicate that the poll request is no longer pending.

If the current finger is not the requesting finger (in step 924), then a determination is made whether or not the current and requesting fingers are on the same channel (step 926). If the answer is no, then the process terminates. Otherwise, a determination is next made whether or not the current and requesting fingers would merge if the pending AR command is allowed to be applied (step 928). Various algorithms may be used to detect for merging, some of which are described below. In one simple algorithm, merging is detected if the difference between the offsets of the current and requesting fingers (with the pending AR command applied hypothetically) is less than the minimum allowed spacing, which is stored in the Offset Spacing register.

A determination is then made whether or not merging was detected (step 930). If the answer is yes, then the Disallow AR register is set (e.g., to “1”) to indicate that the AR command is disallowed. Otherwise, if merging is not detected, then nothing needs to be performed. In either case, the process then terminates.

There may be instances in which a finger sets a poll request and is subsequently dissolved or deleted before the full poll cycle is completed. This may occur, for example, if the multipath component being tracked by that finger vanishes. A mechanism is provided to ensure that a pending poll that was set by an “orphan” finger (i.e., one that has been deleted) can be appropriately deleted by other active fingers.

In a specific scheme for detecting an orphan finger, each finger stores the current poll count value and the ID of the requesting finger as part of its merge protection processing. This may be achieved by copying the values in the Poll Count and Req Finger ID registers in the FMP storage unit into the finger's Last Poll Count and Last Req Finger registers, respectively. This copying may be performed after step 932 in FIG. 9.

At the beginning of the merge protection processing for each finger (e.g., before step 912 in FIG. 9), the current activated finger would compare the values in its Last Poll Count and Last Req Finger registers with those in the Poll Count and Req Finger ID registers, respectively, in the FMP storage unit. If a poll is currently pending and these two sets of values are the same, then an orphan finger is detected. The reason for this is as follows.

The current pending poll should be different than the prior poll encountered by the current finger. The finger that requested the prior poll should have reset the Poll Request register prior to a full cycle back to the current finger. The current pending poll could have been set by the finger that requested the last poll, a new finger, or an orphan finger. Since consecutive polls may be set by the same finger, checking the ID of the last requesting finger alone would not be sufficient. Thus, the poll count value (which is incremented by the requesting finger for each new poll request) is also checked. The poll count may be implemented with a single bit. The poll count value may change multiple times during a finger cycle, and with a minimum size count the poll count value could repeat. Thus, the poll count value and the last requesting finger ID are used to determine an orphan finger with the assumption that two AR requests are not generated by a finger within one finger cycle.

For clarity, the description above assumes that the timing of the fingers is updated one finger at a time (as shown in FIG. 5) and that the fingers are polled in sequential order (as shown in FIG. 6). The finger merge protection techniques described herein may also be used even if finger timing updating and/or finger polling are performed in some other manner. For example, the AR commands may be provided to the fingers as they are available from the associated time tracking loops. Each finger would then store its AR command until it can poll the other fingers.

If multiple AR commands may be concurrently pending for multiple fingers, then the merge protection processing may be performed by each finger as follows. Each activated finger initially checks to see if a poll is currently pending (step 922 in FIG. 9). If the answer is no, then the current activated finger can set a poll request for its AR command, if one is pending (block 910 in FIG. 9). Otherwise, if a poll is currently pending (and not from an orphan finger), then the current finger would process the pending poll and allow or disallow the AR command for the requesting finger (steps 924 through 932 in FIG. 9). If the current finger has a pending AR command and the AR command of the requesting finger is disallowed by the current finger or some other finger, then the current finger can set a new poll request for its own AR command. The prior requesting finger (when its turn comes up again) would then assume that its AR command is disallowed if it detects a new poll request from another finger.

The fingers may also be polled in some other manners instead of sequentially, and this is within the scope of the invention. Different implementations of the polling may be more suitable for different implementations of the merge protection processing. For example, if the merge protection processing for all fingers is performed by a common unit (e.g., channel controller 250), then this unit may poll only fingers on the same channel, for example, based on a finger mask.

The detection for merging may be performed in various manners. In one embodiment, merging is detected if the difference between the offsets of the two fingers being compared (with the pending AR command applied hypothetically) is less than or equal to the offset spacing. An AR command that results in the finger offsets moving away from each other is not disallowed. In another embodiment, the energies of the multipath components being processed by the two fingers are also taken into account to determine merging. Energies or possibly finger number may be used to allow different offsets to be used for some optimization schemes.

The finger merge protection may also be performed in various manners. In a first embodiment, the finger merge protection is performed without preference to any active fingers. Each AR command is processed in the order in which it is received.

In a second embodiment, the finger merge protection is performed such that preference is given to some active fingers over others. For example, in some situations, improved performance may be achieved if fingers assigned to stronger multipath components are allowed to be updated even if applying the command would result in merging with fingers assigned to weaker multipath components. In that case, the fingers assigned to weaker multipath components may be moved instead.

In one implementation of the second embodiment, a set of “preferred” active fingers is identified based on the signal strength of their multipath components. This signal strength may be computed by a received signal strength indicator (RSSI) based on the received pilot. The signal strength may be determined periodically for the active fingers. The finger merge protection would then favor the preferred fingers over the non-preferred fingers. In particular, if applying an AR command for a given preferred finger would cause it to be too close to another non-preferred finger, then the AR command would still be applied for the preferred finger. Another AR command would be applied to the non-preferred finger to remedy the merging of the fingers (i.e., to separate the finger offsets by at least the offset spacing).

For clarity, specific embodiments of the finger merge protection with polling have been described for a TDM demodulator design. Other embodiments may also be contemplated based on the teachings described herein. For example, the finger merge protection with polling may also be used for a demodulator design in which the fingers are implemented with independent units. The fingers may still be polled for each AR command to detect for possible merging.

The finger merge protection techniques described herein may be used in various wireless communication systems. For example, these techniques may be used in CDMA, time division multiple access (TDMA), frequency division multiple access (FDMA), and other wireless communication systems. These systems may implement one or more applicable standards. For example, the CDMA systems may implement WCDMA, IS-2000, IS-95, and so on. The TDMA systems may implement GSM and so on. These various standards are known in the art. The techniques described herein may also be used for downlink transmissions as well as uplink transmissions.

The techniques described herein may be implemented by various means. For example, the finger merge protection with polling may be implemented in hardware, software, or a combination thereof. For a hardware implementation, various elements used for finger merge protection (e.g., FMP unit 232 and FMP storage unit 260) may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof.

For a software implementation, the finger merge protection may be implemented with modules (e.g., procedures, functions, and so on) that perform the functions described herein. For example, some or all of the functions performed for finger merge protection (e.g., the process shown in FIG. 9) may be implemented with software modules. The software codes may be stored in a memory (e.g., memory unit 162 in FIGS. 1 and 2) and executed by a processor (e.g., controller 160). This memory unit may be implemented within the processor or external to the processor, in which case it can be communicatively coupled to the processor via various means as is known in the art.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A device operable to prevent merging of demodulation elements (fingers), comprising:
a storage unit operative to store parameter values used for merge protection processing; and
at least one finger merge protection (FMP) unit operative to set a poll request for a command to adjust timing of a designated finger, and to poll one or more other fingers for possible merging with the designated finger for the poll request.

2. The device of claim 1, wherein one FMP unit is provided for each finger, and wherein each FMP unit is operative to check for merging if a poll request is pending.

3. The device of claim 2, wherein each FMP unit is further operative to set a new poll request if a command to adjust the timing of the associated finger is pending and no poll requests are pending.

4. The device of claim 2, wherein FMP units for the fingers are implemented by one processing unit in a time division multiplexed (TDM) manner.

5. The device of claim 1, wherein the command to adjust the timing of the designated finger is disallowed if merging is detected for any one of the one or more fingers.

6. The device of claim 5, wherein merging with a particular finger is detected if a difference between offsets of the designated finger and the particular finger is less than or equal to a particular offset spacing.

7. The device of claim 6, wherein the particular offset spacing is less than one PN chip.

8. The device of claim 1, wherein the one or more fingers are polled in sequential order for possible merging with the designated finger.

9. The device of claim 1, wherein the FMP unit is further operative to determine whether or not the designated finger has been deleted, and to cancel the poll request if the designated finger has been deleted.

10. The device of claim 1, wherein a set of preferred fingers is identified, and wherein the designated finger, if it is a preferred finger, is allowed to be adjusted even if merging is detected with a non-preferred finger.

11. The device of claim 10, wherein the preferred fingers are identified based on received signal strength.

12. The device of claim 1, and operative in a CDMA system that implements W-CDMA, IS-2000, or IS-95.

13. In a CDMA communication system, a device operable to prevent merging of demodulation elements (fingers) assigned to process a plurality of multipath components in a received signal, comprising:
a storage unit operative to store parameter values used for merge protection processing; and
a finger merge protection (FMP) unit for each finger, each FMP unit operative to set a poll request for a command to adjust timing of the associated finger if no poll requests are currently pending, and to check for merging with a requesting finger that sets a current poll request if one is pending, and wherein the command to adjust the timing of the designated finger is disallowed if merging is detected.

14. An apparatus operable to prevent merging of demodulation elements (fingers), comprising:
means for receiving a command to adjust timing of a designated finger;
means for polling one or more other fingers for possible merging with the designated finger due to the command; and
means for adjusting the timing of the designated finger in accordance with the command if the command is not disallowed by the one or more other fingers.

15. The apparatus of claim 14, wherein the means for polling includes
means for setting a poll request by initializing a set of registers with a set of parameter values for the designated finger, and
means for checking each of the one or more fingers for merging with the designated finger based in part on the set of parameter values, and wherein the command is disallowed if merging with any one of the one or more fingers is detected.

16. An integrated circuit comprising:
a plurality of demodulation elements (fingers) operative to process a plurality of multipath components in a received signal; and
a plurality of finger merge protection (FMP) units, one for each finger, each FMP unit operative to set a poll request for a command to adjust timing of the associated finger if no poll requests are currently pending, and to check for merging with a requesting finger that sets a current poll request if one is pending, and wherein the command to adjust the timing of the requesting finger is disallowed if merging is detected.

17. The integrated circuit of claim 16, further comprising:
a storage unit operative to store a set of parameter values used for merge protection processing.

18. The integrated circuit of claim 16, wherein the plurality of fingers and FMP units are implemented by one processing unit in a time division multiplexed (TDM) manner.

19. A base station in a wireless communication system, comprising:
a demodulator including a plurality of demodulation elements (fingers) operative to process a plurality of multipath components in a received signal; and
a plurality of finger merge protection (FMP) units, one for each finger, each FMP unit operative to set a poll request for a command to adjust timing of the associated finger if no poll requests are currently pending, and to check for merging with a requesting finger that sets a current poll request if one is pending, and wherein the command to adjust the timing of the requesting finger is disallowed if merging is detected.

20. A terminal in a wireless communication system, comprising:
a demodulator including a plurality of demodulation elements (fingers) operative to process a plurality of multipath components in a received signal; and
a plurality of finger merge protection (FMP) units, one for each finger, each FMP unit operative to set a poll request for a command to adjust timing of the associated finger if no poll requests are currently pending, and to check for merging with a requesting finger that sets a current poll request if one is pending, and wherein the command to adjust the timing of the requesting finger is disallowed if merging is detected.

21. In a wireless communication system, a method for preventing merging of demodulation elements (fingers) assigned to process a plurality of multipath components in a received signal, comprising:
receiving a command to adjust timing of a designated finger;
polling one or more other fingers for possible merging with the designated finger due to the command; and
adjusting the timing of the designated finger in accordance with the command if the command is not disallowed by the one or more other fingers.

22. The method of claim 21, wherein the polling includes
setting a poll request by initializing a set of registers with a set of parameter values for the designated finger, and
checking each of the one or more fingers for merging with the designated finger based in part on the set of parameter values, and wherein the command is disallowed if merging with any one of the one or more fingers is detected.

23. The method of claim 21, wherein merging with a particular finger is detected if a difference between offsets of the designated finger and the particular finger is less than or equal to a particular value.

24. The method of claim 21, wherein the received signal is an uplink signal in a CDMA system.
